(19) United States
(12) Patent Application Publication
(10) Pub. No.: US 2017/0154386 A1
(43) Pub. Date: Jun. 1, 2017

(54) VEHICLE MANUFACTURE TRACKING

(71) Applicant: Telogis, Inc., Aliso Viejo, CA (US)

(72) Inventors: Reza Hemmati, Carlsbad, CA (US); Scott Buckland, Rolleston (NZ); Mark L. Wallin, Irvine, CA (US); Jason M. Koch, Huntington Beach, CA (US); Bjørn Tore Svinterud, Solana Beach, CA (US)

(21) Appl. No.: 15/364,137

(22) Filed: Nov. 29, 2016

Related U.S. Application Data
(60) Provisional application No. 62/261,036, filed on Nov. 30, 2015.

(51) Int. Cl. G06Q 50/04; G06Q 10/08; G06Q 10/10

(52) U.S. Cl. CPC G06Q 50/04; G06Q 10/103; G06Q 10/087

(57) ABSTRACT

Systems and methods disclosed herein use a tracking device or system installed during an early stage of a manufacturing process to determine a location of a vehicle under manufacture. This tracking device enables the status of the vehicle to be determined even when multiple entities are involved in the manufacturing process of the vehicle. Advantageously, in certain embodiments, by tracking the manufacturing process of the vehicle across manufacturers, distribution of workload among manufactures may be improved resulting in more efficient manufacturing. Further, requisitions can more accurately distribute vehicle assignments in advance of receipt of new vehicles resulting in additional optimizations in work-load distribution.

### PRIORITY APPLICATIONS AND INCORPORATION BY REFERENCE

This application claims the benefit of U.S. Provisional Patent Application No. 62/261,036, filed Nov. 30, 2015, and entitled “VEHICLE MANUFACTURE TRACKING,” which is hereby incorporated by reference in its entirety for all purposes. Any and all applications, if any, for which a foreign or domestic priority claim is identified in the Application Data Sheet of the present application are hereby incorporated by reference in their entireties under 37 CFR 1.57.

### BACKGROUND

Some entities or organizations employ a large number of trucks or other vehicles. For example, some delivery or logistics companies may own or maintain thousands of trucks. In such cases, vehicles may be purchased or replaced on a rolling basis with new vehicles being delivered periodically.

For some entities, maintaining operation of a large fleet of vehicles is important to keeping the business in operation. Thus, it is important to know how many vehicles are functional and are available for distribution among drivers. If an accurate determination of available vehicles is not determined, there may exist drivers without vehicles or cargo to be delivered without a vehicle to deliver the cargo. Similarly, without an accurate determination of available vehicles, there may exist empty vehicles sitting within an entity's parking lot. Underutilized vehicles can cost a business money due to, for example, maintenance, storage, and insurance expenses. Thus, it is important to accurately determine the extent of an entities vehicle fleet. This determination can be challenging entities that maintain large vehicle fleets due, for example, to the frequency of the vehicle fleet changing due, for example, to retirement of older vehicles and the delivery of newly acquired vehicles.

### BRIEF DESCRIPTION OF THE DRAWINGS

Throughout the drawings, reference numbers are re-used to indicate correspondence between referenced elements. The drawings are provided to illustrate embodiments of the inventive subject matter described herein and not to limit the scope thereof.

FIG. 1 illustrates an embodiment of a vehicle manufacturing-status system.

FIG. 2A illustrates an embodiment of an annotated map for determining the assembly status of a vehicle.

FIG. 2B illustrates an embodiment of an annotated map for determining the assembly status of a vehicle based on sub-locations within a particular location identified in the map of FIG. 2A.

FIG. 3 illustrates an embodiment of a user interface for tracking the manufacturing status of a vehicle fleet.

FIG. 4 illustrates an embodiment of a user interface for accessing vehicle information for vehicles under construction at a particular manufacturing stage.

FIG. 5 illustrates an embodiment of a second user interface for accessing vehicle information for vehicles under construction at a particular manufacturing stage.

FIG. 6 illustrates an embodiment of a third user interface for accessing vehicle information for vehicles under construction at a particular manufacturing stage.

FIG. 7 illustrates an embodiment of a portion of a user interface for presenting the assembly status of a vehicle.

FIG. 8 presents a flowchart of an embodiment of a vehicle status monitoring process.

FIG. 9 illustrates an embodiment of a vehicle management system.

### DETAILED DESCRIPTION

### Introduction

For fleet management purposes, it can be helpful to track the manufacturing status of one or more vehicles requisitioned for the fleet. However, it is often difficult to ascertain the manufacturing status of a vehicle because multiple manufacturers may be involved in manufacturing the vehicle. It can be challenging to ascertain the manufacturing status of the vehicle when multiple manufacturers are involved because one manufacturer does not necessarily have insight into or knowledge of what is occurring in another manufacturer's facility. This disclosure can be applied to various types of vehicles, such as aircraft, boats, tractors, motorcycles, cranes, and construction vehicles. Further, this disclosure may be applied to commercial vehicles (such as delivery trucks or service maintenance vehicles) or consumer vehicles (such as private or personal cars). In some cases, the present disclosure may be applied to non-vehicular equipment. However, to simplify the discussion and not to limit the present disclosure, the remainder of this disclosure will primarily be described with respect to trucks, such as, but not limited to, long-haul shipping trucks, refrigerator trucks, gasoline distribution trucks, and the like.

One solution to ascertain the manufacturing status of a vehicle is to install some form of tracking software within each manufacturers computing network. However, the solution can be challenging to implement because it requires a number of independent entities to agree to install the tracking software. Some entities may be hesitant to install such tracking software for a number of reasons, such as privacy or trade secret concerns. Further, some manufacturers may produce products or help to manufacture vehicles from multiple independent manufacturers. Thus, it may be impractical or, in some cases, even impossible for some manufacturers to install the tracking software in their network.

Another solution is for an original or first manufacturer involved in the manufacturing of a vehicle to install a tracking device within the vehicle being manufactured. This tracking device may be a hardware-based tracking device, a software package installed in a computing system of the vehicle, or a combination of hardware and software. Further details of this tracking device are described herein. The tracking device may be used to identify the location of the vehicle being manufactured during the manufacturing process. By identifying the location of the vehicle being manufactured, a manufacturing or assembly status of the vehicle may be determined. Advantageously, in certain embodiments, by the installation of the tracking device into the vehicle by the first manufacturer, the manufacturing status of the vehicle can be determined without the first manufacturer, or some other entity, negotiating access to computing systems of other manufacturers involved in the manufacturing process of the vehicle.

Embodiments of the present disclosure may be applied to a single manufacturer that distributes the manufacturing process of the vehicle across multiple locations. However, to simplify discussion and not to limit the present disclosure, much of the present disclosure is described with respect to the manufacturing of a vehicle using multiple manufacturers or entities. For example, one manufacturer of a truck may manufacture or assemble the cab, the engine, and a rear part of the truck as a bare frame (these elements may, in some cases, be referred to as the “base vehicle” or the “core of the truck”). In some cases, the core of the truck may be drivable and/or usable without any further components or manufacturing processes. In other cases, the core of the truck may require additional components or manufacturing before the truck may be used or driven commercially, legally within a particular geopolitical area, or at all.

One or more additional manufacturers, or outfitters, may be responsible for manufacturing or assembling other portions of the truck that are added to the core of the truck. These other portions of the truck may be application-specific elements that are added to the vehicle. For example, another manufacturer may be responsible for installing a custom rear end to the truck, such as a flatbed, a container, or some type of box. As another example, another manufacturer may be responsible for installing a refrigeration system in the container installed on the truck. Further, yet another manufacturer may be responsible for painting a requisitioning entity's custom paint scheme and/or logo on the truck. In some cases, the additional elements added to the base vehicle may be required for the vehicle to function in a commercial setting, legally, or at all.

Advantageously, by installing the tracking device in the vehicle being manufactured, an entity, such as the first manufacturer or the requisitioning entity, can determine the manufacturing status of the vehicle including, for example, whether the vehicle is within a geographic area or zone associated with the manufacturer responsible for installing the rear end, installing the refrigeration system, or painting the vehicle. Consequently, a manufacturing status of the vehicle can be determined enabling the requisitioning entity to more accurately plan for the delivery of the vehicle. Advantageously, in certain embodiments, by obtaining more fine-grained status information compared to traditional systems, an entity (or associated user) can more accurately plan for the receipt and integration of the vehicle into the entity's routing and driver assignment platforms. Further, in some embodiments, the amount of status inquiries received by a dealer or other vehicle provider is reduced because, for example, of the ability of the requisitioning entity to obtain the fine-grained status information provided by the present disclosure. The reduction in status inquiries enables the vehicle provider to focus on other tasks, thereby reducing costs to the vehicle provider. As a further advantage, the original equipment manufacturer (OEM) or the initial manufacturer may use features of the present disclosure to identify outfitters currently having delays or outfitters with a history of delays. Advantageously, in certain embodiments, the OEM can make this determination without requiring the outfitters to provide access to systems managed by the outfitter. Further, the OEM can use this information to select outfitters, to negotiate terms with the outfitters, to schedule allocation of tasks to particular outfitters, to estimate delivery times of products, and the like.

As used herein, the first manufacturer or manufacturer responsible for manufacturing the core of the truck may be referred to as the original manufacturer or the initial manufacturer. Typically, this original manufacturer is the manufacturer from which the vehicle or truck is requisitioned by a customer or a user, or by a dealer. In some cases, the first manufacturer may be the primary manufacturer and may or may not be the first manufacturer involved in the process of manufacturing the vehicle. In other words, in some cases, the first manufacturing steps involved in creating the vehicle may be performed by a vendor or outfitter.

Subsequent or additional manufacturers may be referred to as outfitters, up-fitters, or vendors. It should be understood that the term used to refer to the initial original manufacturer and the term used to refer to the outfitter or subsequent manufacturer is not intended to be limiting. This disclosure may generally relate to vehicles that are manufactured, assembled, outfitted, or otherwise configured by more than one manufacturer before being delivered to an entity that requisitioned the vehicle. Further, although this disclosure is generally related to the use of multiple manufacturers to manufacture a single instance of a vehicle or a fleet of vehicles, in some cases, this disclosure may be applied to a single manufacturer that uses multiple manufacturing locations to assemble or otherwise manufacture a single vehicle or a fleet of vehicles.

### Example Vehicle Manufacturing-Status System

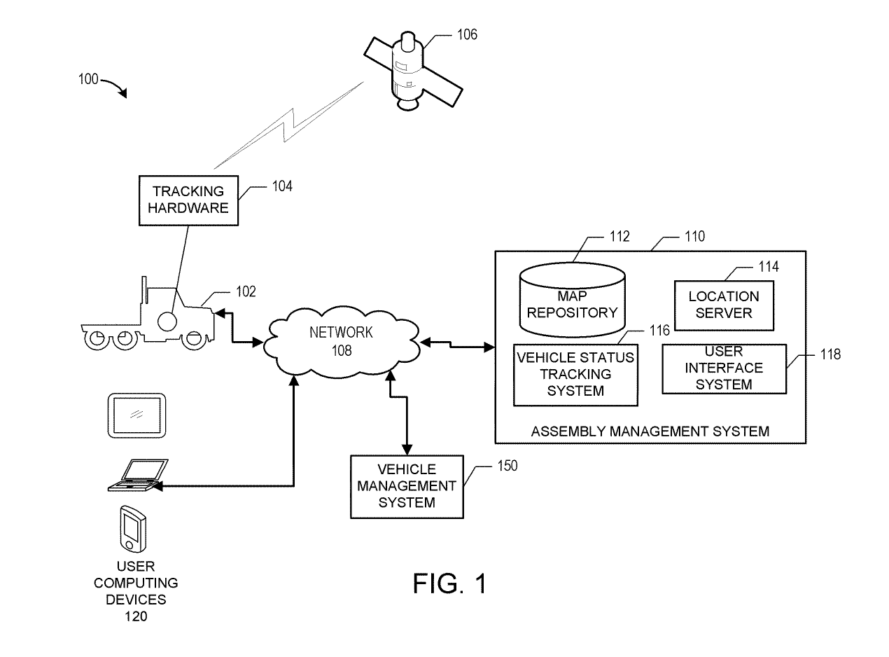

FIG. 1 illustrates an embodiment of a vehicle manufacturing-status system 100. Although FIG. 1 illustrates a single vehicle 102, it should be understood that the vehicle manufacturing-status system 100 can be used to track the status of a plurality of vehicles or an entire fleet of vehicles. As previously discussed, a first or initial manufacturer of the vehicle 102 may install a tracking device, such as the tracking hardware 104, into the vehicle 102 at a stage of the manufacturing process performed by the first manufacturer of the vehicle 102. It is advantageous for the first manufacturer of the vehicle 102 to install the tracking hardware 104 because, for example, the status of the vehicle 102 may be determined over a longer time period compared to use cases where the tracking hardware 104 is installed by a subsequent manufacturer. However, this disclosure is not limited as such, and a later manufacturer of the vehicle 102, such as a second or third manufacturer involved in the manufacturing of the vehicle 102 may install the tracking hardware 104.

The tracking hardware 104 may be implemented entirely in hardware or may be implemented as a combination of hardware and software. Further, the tracking hardware 104 is not limited in form and may be comprised of various types of hardware. For example, the tracking hardware 104 may be a receiver configured to receive a signal from a source that can be used to determine a location of the vehicle 102. For instance, the tracking hardware 104 may be a space-based navigation system receiver configured to receive a signal from a satellite, such as the satellite 106. Thus, in some cases, the signal may be a global positioning system (GPS) signal. The tracking hardware 104 may then use the signal received from the satellite to determine the location of the vehicle 102. In some cases, the tracking hardware 104 may receive multiple signals from multiple satellites to facilitate determining the location of the vehicle 102 using, for example, a triangulation process. In some cases, the satellite 106 may represent a satellite included in a space-based navigation system, such as a global positioning system (GPS). Further, although illustrated as a single satellite, the satellite 106 may represent a plurality of satellites.

In some embodiments, the tracking hardware 104 may determine the location of the vehicle 102 using alternative means. For example, the tracking hardware 104 may receive one or more signals from cellular towers or wireless routers. The tracking hardware 104 may then use these received signals to determine the location of the vehicle 102 during the manufacturing process of the vehicle 102.

The tracking hardware 104 may provide the location information for the vehicle 102 being manufactured to an assembly management system 110. This location information may be provided via a network 108. The network 108 may be a publicly accessible network or a network of linked networks, possibly operated by various distinct parties. Further, in some cases, the network 108 may include the Internet. In other embodiments, the network 108 may include a private network, personal area network, local area network, wide area network, cable network, satellite network, cellular telephone network, etc., or combination thereof, each with access to and/or from an external network, such as the Internet. In some cases, the network 108 is the Internet.

The assembly management system 110 may include any system capable of determining the manufacturing status of the vehicle 102 being manufactured. The assembly management system 110 may be implemented using computer hardware, software, or a combination of hardware and software. Further, the assembly management system 110 may be associated with an entity that requisitioned the vehicle 102, an entity associated with manufacturing the vehicle 102, or an entity that is independent of the one or more manufacturers of the vehicle 102 and the entity that requisitioned the vehicle 102.

The assembly management system 110 may include a number of systems or subsystems to facilitate determining the manufacturing status of the vehicle 102. For example, the assembly management system 110 may include a map repository 112, a location server 114, a vehicle status tracking system 116, and a user interface system 118. Each of these systems or subsystems of the assembly management system 110 may be separate hardware systems or software modules implemented by the assembly management system 110.

The map repository 112 may include any type of repository or data storage system capable of storing one or more maps. Alternatively, or in addition, the map repository 112 may store the identity of one or more manufacturers or manufacturing locations associated with one or more geographic locations. For example, the map repository 112 may store a lookup table that can be accessed to determine a manufacturing location using a geographic location as a key to access the lookup table.

The location server 114 may include any type of system that is capable of determining a manufacturer or a manufacturing facility where the vehicle 102 is located. In some cases, the location server 114 may determine the facility where the vehicle 102 is located based on a geographic location for the vehicle 102 supplied by the tracking hardware 104. Further, in some cases, the location server 114 may access the map repository 112 to determine the facility where the vehicle 102 is located using the geographic location of the vehicle 102 supplied by the tracking hardware 104.

The vehicle status tracking system 116 may include any system capable of determining the manufacturing status of the vehicle 102. In some cases the vehicle status tracking system 116 may determine the manufacturing status of the vehicle 102 using the identity of the manufacturing facility where the vehicle 102 is located as determined by, for example, the location server 114. Further, the vehicle status tracking system 116 may determine the vehicle 102 manufacturing status based on the history of locations at the vehicle 102 has visited as determined, for example, by the location server 140.

The user interface system 118 may include any system capable of displaying or outputting for display the manufacturing or assembly status of the vehicle 102. In some cases, the assembly status or information associated with the assembly status of vehicle 102 may be provided via the network 108 to one or more user computing devices 120. The user computing devices 120 can include a wide variety of computing devices, including personal computing devices, terminal computing devices, laptop computing devices, tablet computing devices, electronic reader devices, mobile devices (e.g., mobile phones, media players, handheld gaming devices, etc.), wearable devices with network access and program execution capabilities (e.g., “smart watches” or “smart eyewear”), wireless devices, set-top boxes, gaming consoles, entertainment systems, televisions with network access and program execution capabilities (e.g., “smart TVs”), kiosks, speaker systems, and various other electronic devices and appliances. Advantageously, users associated with the user computing devices 120 may determine the manufacturing status of a vehicle 102 without contacting the manufacturer. Further, users associated with the user computing devices 120 may obtain a more fine-grained status of the vehicle 102 being manufactured compared to systems that do not utilize tracking hardware 104 to determine the location of the vehicle 102 being manufactured.

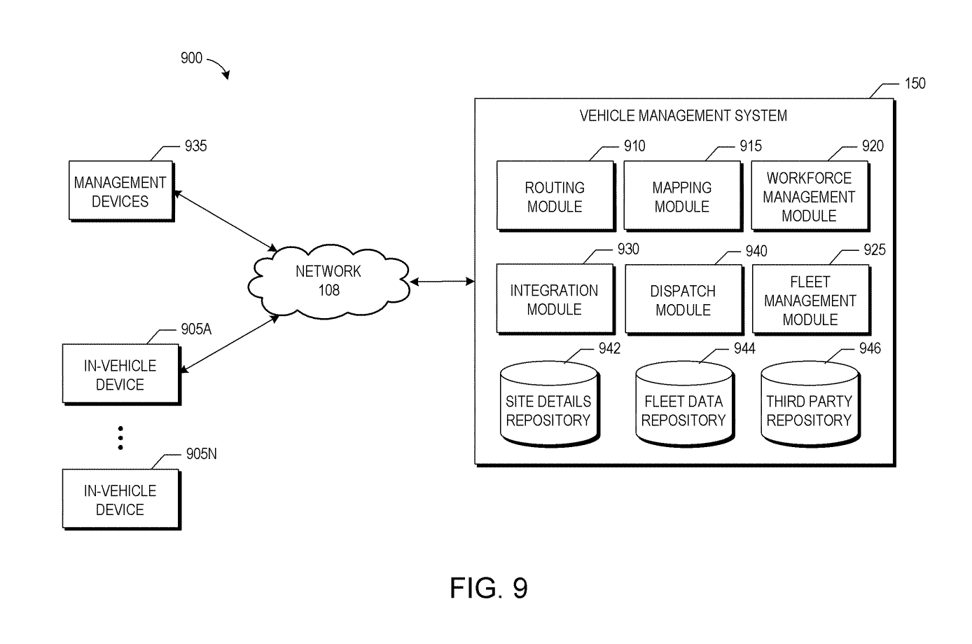

In some embodiments, the assembly status or information associated with the assembly status of vehicle 102 may be provided via the network 108 to a vehicle management system 150. The vehicle management system 150 may include any system for managing a fleet of vehicles, driver assignments, and/or routes for the fleet of vehicles. Further, the vehicle management system 150 may be associated with a particular entity, such as the entity that requisitioned the vehicle 102. The vehicle management system 150 is described in more detail below with respect to FIG. 9.

### Example Annotated Map

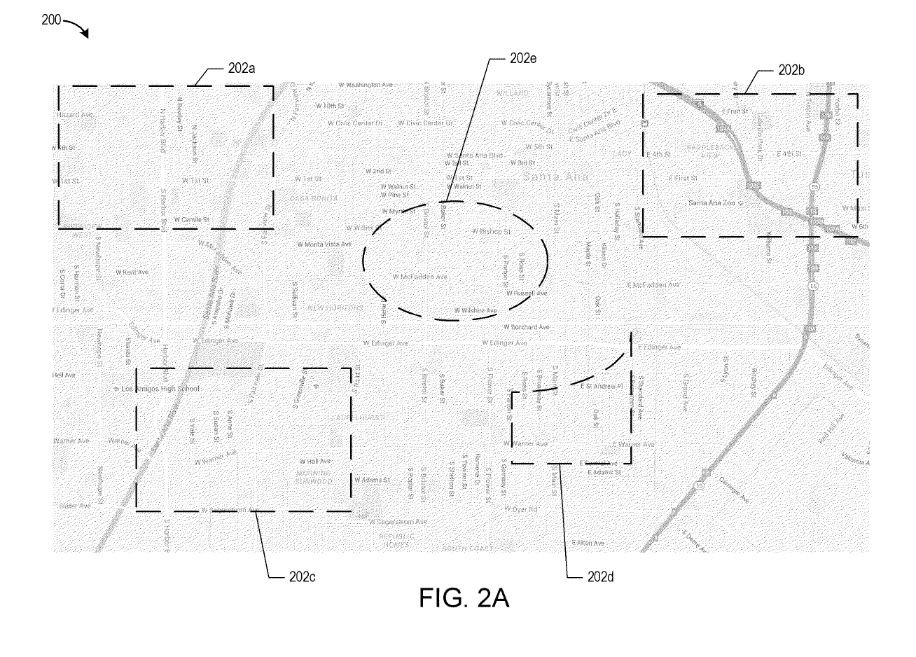

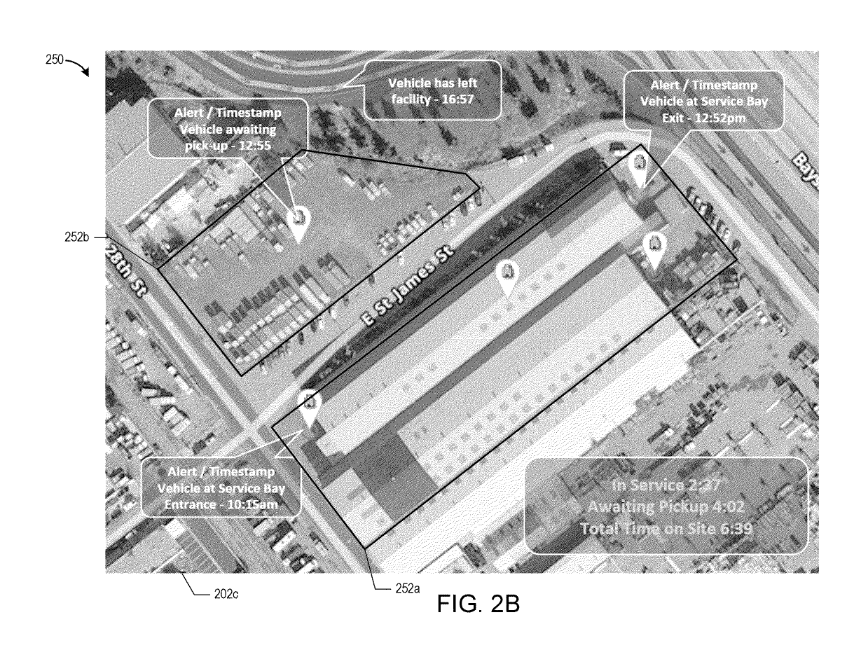

FIG. 2A illustrates an embodiment of an annotated map 200 for determining the assembly status of a vehicle 102. The annotated map 200 may be stored by the map repository 112 of the assembly management system 110. Alternatively, or in addition, the map repository 112 may store information associated with the map 200 that enables the location server 114 to re-create the map 200 and/or to determine a location of the vehicle 102 with respect to one or more manufacturing sites or locations that may be involved in the manufacture of the vehicle 102.

The map 200 may include one or more geo-fenced locations. The geo-fenced locations may comprise virtually mapped fences around particular geographic areas that are associated with a particular manufacturing site. In other words, in certain embodiments, fictitious fences may be located around a particular manufacturing site. For example, in FIG. 2A, the map 200 includes five geo-fenced locations 202a, 202b, 202c, 202d, 202e, which may be referred to collectively as geo-fenced locations 202. Although geo-fenced locations 202a, 202b, 202c are rectangular, as illustrated by the geo-fenced locations 202d and 202e, the geo-fenced locations need not be rectangular, but may include any shape that can be used to identify a geographic region. Further, although geo-fences are generally conceptual or virtual, in some cases, a geo-fence may coincide, at least partially, with an actual fence or a physical border, such as a river, that exists in the real world.

The status of the vehicle 102 may be determined based on the location of the vehicle 102 with respect to the geo-fenced locations 202 within the map 200. If it is determined that the vehicle 102 has entered, has exited, is traveling towards, is traveling away from, or is within a geographic region 200 surrounded by the fictitious or virtual fence, a manufacturing status of the vehicle 102 may be ascertained. In some cases, a problem with the assembly of the vehicle 102 may be identified based on an unexpected location of the vehicle 102. For example, suppose at one point in time the vehicle 102 exits a manufacturing site fenced by the geo-fenced location 202b. Further, suppose that the vehicle 102 is not expected to reenter the manufacturing site associated with the geo-fence location 202b. If at a later point in time the vehicle 102 is detected entering the geo-fenced location 202b, it may be determined that there was a problem with the assembly of the vehicle 102, either during its time at the manufacturing location associated with the geo-fenced location 202b or during its time at a another manufacturing location.

In some cases, the assembly management system 110 may track not only the location of the vehicle 102 as determined from the tracking hardware 104, but may also monitor the amount of time the vehicle 102 is at a particular location as well as when the vehicle 102 enters or exits a particular location as identified based on the location of the vehicle 102 with respect to one of the geo-fenced locations 202. Advantageously, in certain embodiments, by determining how long the vehicle 102 is at a particular location and/or by determining when vehicle 102 enters or exits a particular location, the assembly management system 110 may determine whether a manufacturer or outfitter is operating at schedule, behind schedule, or ahead of schedule. By determining whether a particular manufacturer or outfitter is operating within a particular schedule, a workflow or manufacturing process may be modified for one or more additional vehicles being manufactured. For example, the assembly management system 110 can redirect the order in which a particular vehicle being manufactured visits one or more manufacturing locations. As another example, the assembly management system 110 can alter which outfitter or vendor is selected to work on a particular vehicle being manufactured based on whether the outfitter, vendor, or manufacturer is operating within the particular schedule or whether an alternative outfitter, vendor, or manufacturer is operating within a particular schedule.

In some embodiments, the manufacturing status of the vehicle 102 being manufactured may be determined based at least in part on the location of the vehicle 102 within a particular geo-fenced site. Thus, in some cases, the geo-fenced sites may be created as a hierarchy of locations. In certain implementations, a particular geo-fenced site may be divided into a plurality of geo-fenced sub-sites or sub-locations. Further, in some cases, the status of the vehicle 102 being manufactured may be based at least in part on the amount of time the vehicle 102 is at a particular location or at a particular sub-location, or the number of times the vehicle 102 has entered or exited a particular location or sub-location.

FIG. 2B illustrates an embodiment of an annotated map 250 for determining the assembly status of a vehicle based on sub-locations within a particular location 202c identified in the map of FIG. 2A. As illustrated in FIG. 2B, the geo-fenced location 202c may be divided into two (or more) geo-fenced sub-sites 252a and 252b (collectively referred to as sub-sites 252). These geo-fenced sub-sites 252 may be locations within a manufacturing facility. For example, the geo-fenced sub-site 252a may be a service bay where a crane may be installed on a core of the vehicle 102. The geo-fenced sub-site 252b may be a yard where vehicles that have been processed at the service bay are parked to await transport to the next outfitter or for delivery. In some cases, the geo-fenced sub-sites 252 may comprise a building and a space external to a building (as illustrated in FIG. 2B), multiple buildings, or a single building that is divided into multiple areas. Further, in some cases, a site (e.g., the site 202c) may be divided into several tiers of sub-sites. For example, the sub-site 252a may be further divided into three sub-sites and one or more of the sub-sites may be divided into yet additional sub-sites. In some embodiments, by tracking the number of vehicles within the sub-site 252a or the sub-site 252b, the rate of manufacture can be determined. Moreover, based on the determined rate of manufacture, the frequency of vehicles and/or supplies provided to the location 202c may be modified to alter or maintain the rate of manufacture of the vehicles at the location 202c.

The manufacturing status of the vehicle 102 may be determined based on the location of the vehicle 102 within the sub-sites. For instance, suppose that the site 202c is the facility of an outfitter that performs the painting process for painting the vehicle 102. It may be determined, based on the sub-site location within the site 202c, that the painting process for the vehicle 102 is backlogged or that the vehicle is staged for painting, being painted, drying, or waiting for pickup based on the sub-site within the site 202c. Each of these states may be associated with its own geo-fence that can be used to infer a more fine-grained level of detail than might be gleaned from a single marker that identifies the vehicle as being “at the paint outfitter.”

In addition, in some embodiments, the status of the vehicle 102 may be determined based on a particular route or access path being traveled by the vehicle 102 being manufactured. For instance, if it is determined that the vehicle 102 is travelling an access path to an entrance of the sub-site 252a, it may be determined that the vehicle is being prepared for painting. On the other hand, if it is determined that the vehicle 102 is travelling an access path from an exit of the sub-site 252a, possibly to an entrance of sub-site 252b, it may be determined that the paint process is completed and that the vehicle 102 is awaiting transport to its next manufacturing destination, or to its delivery destination. Some examples of the generation and use of access paths, and sub-sites that may be used in the present disclosure, are disclosed in U.S. application Ser. No. 14/285,500, filed on May 22, 2014 and titled “CONTEXT-BASED ROUTING AND ACCESS PATH SELECTION,” and U.S. application Ser. No. 15/070,809, filed on Mar. 15, 2016 and titled “CONTEXT-BASED ROUTING AND ACCESS PATH SELECTION,” which are hereby incorporated by reference in their entirety.

### Example User Interfaces

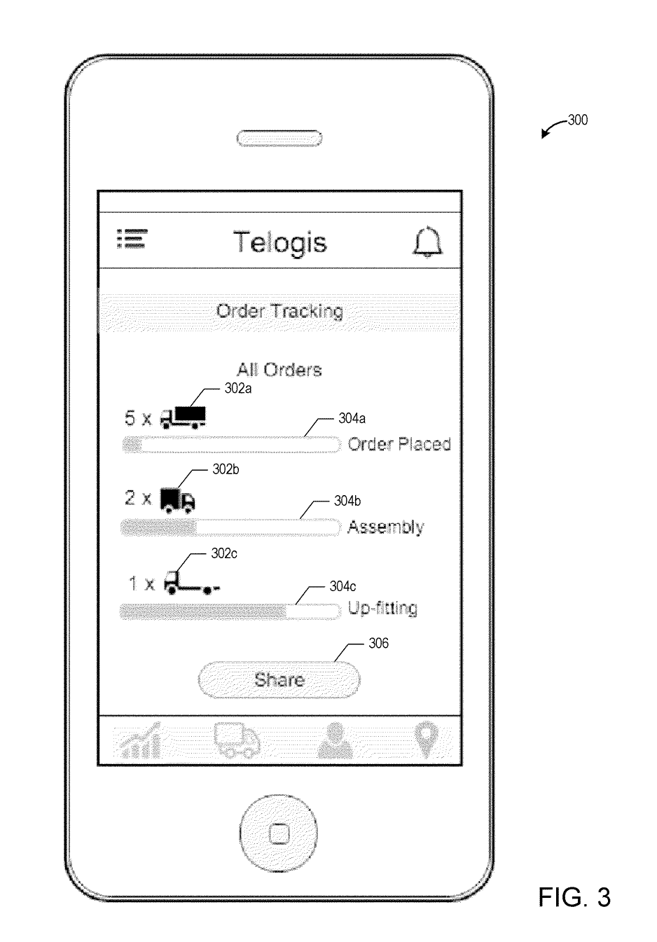

As described above, in some embodiments, the present disclosure may be used to provide the status of a vehicle 102 or a fleet of vehicles being manufactured by one or more manufacturers or at one or more manufacturing locations. The status information may be presented to a user or representative of an entity that requisitioned (e.g., ordered, leased, or purchased, or otherwise requested) the vehicle 102 or a fleet of vehicles. Alternatively, or in addition, the status information may be presented to a manufacturer, such as the manufacturer of the core of the truck. FIGS. 3-7 illustrate several example user interfaces for presenting or providing various forms of the status information to a user. Although many of the user interfaces are presented on a mobile device (e.g., a smart phone), it should be understood that one or more of the user interfaces may be displayed on any type of user computing device 120.

Each of the user interfaces illustrated in FIGS. 3-7 may be generated by the assembly management system 110 using, for example, the user interface system 118. Alternatively, the user interfaces may be generated by one or more of the user computing devices 120 based on information provided by the assembly management system 110. In some cases, the user interfaces may be generated in part by the assembly management system 110 and in part by the user computing devices 120.

In some embodiments, some of the information included in the user interfaces illustrated in FIGS. 3-7 may be presented or may be obscured based on one or more business rules. For example, certain information may be displayed only to users affiliated with a manufacturer. For instance, information indicating a problem with a particular manufacturing step performed by an outfitter and resulting in a delay of delivery may be obscured from an entity that requisitioned the vehicle, but may be presented to the manufacturer. As another example, the geographic location of an outfitter may be presented to the employee of a manufacturer, but not to an employee of an entity that requisitioned the vehicle.

FIG. 3 illustrates an embodiment of a user interface 300 for tracking the manufacturing status of a vehicle fleet. As illustrated by the user interface 300, the status information may be provided for a plurality of vehicles, or a portion of the vehicle fleet. In some cases, the plurality of vehicles may be grouped by vehicle type as illustrated by the icons 302a, 302b, and 302c (collectively referred to as icons 302). Alternatively, or in addition, the plurality of vehicles may be grouped by their manufacturing status. In other words, each status indicator, represented by the status bars 304a, 304b, and 304c (collectively referred to as status bars 304) in FIG. 3, may be associated with the number of vehicles that are associated with the corresponding manufacturing state of the status indicator.

In some cases, each icon 302 and/or each status bar 304 may be interacted with to obtain additional information about the vehicles represented by the individual icons 302 and/or the individual status bars 304. For example, by interacting with one of the icons 302 and/or one of the status bars 304, detailed status information may be provided for the corresponding set of vehicles or for each vehicle within a set of vehicles represented by one of the icons 302 and/or one of the status bars 304. For instance, the detailed status information may indicate how much ahead of schedule or how far behind schedule a set of vehicles is in the manufacturing process.

The user interface 300 may include a share button 306 that enables a user to share the status information for one or more vehicles with other users. In some cases, the share button 306 enables the user to share the status information with one or more systems, such as the vehicle management system 150. Advantageously, in certain embodiments, by sharing the status information with the vehicle management system 150, the vehicle management system 150 may trigger or initiate actions related to receiving the vehicles or the delivery of the vehicles. Further, the vehicle management system 150 may integrate vehicles that are to be delivered within a particular period of time into a routing system or a driver/route assignment system. By integrating vehicles into a routing system or a driver/route assignment system prior to receiving the vehicles, but in anticipation of receiving the vehicles, the distribution and assignment of drivers and routes may be optimized resulting in additional savings in time, money, and fuel expenditure for an entity or business compared to systems that cannot integrate new vehicles until after delivery of a new vehicle.

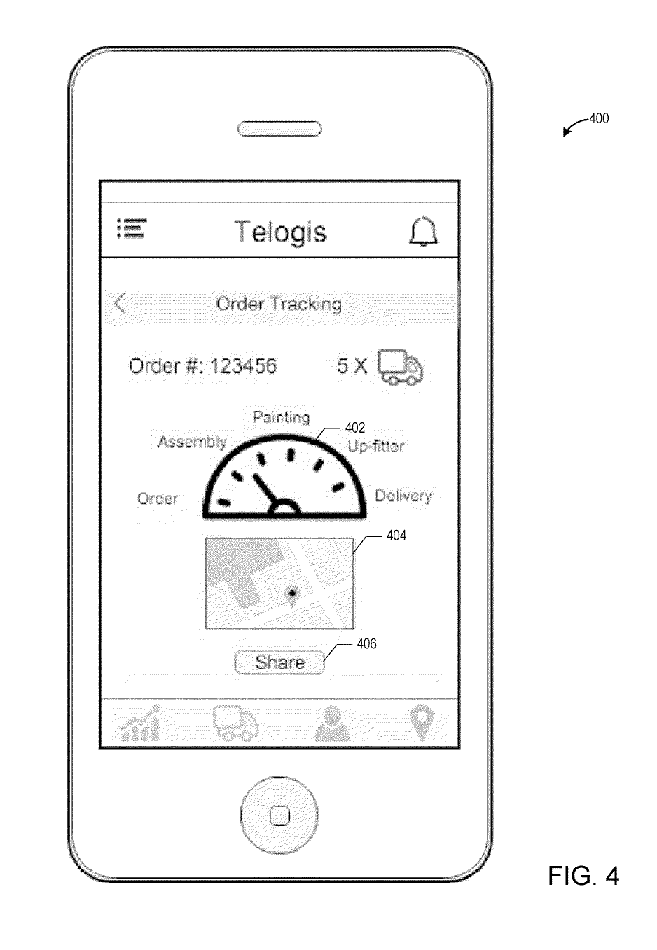

FIG. 4 illustrates an embodiment of a user interface 400 for accessing vehicle information for vehicles under construction at a particular manufacturing stage. The user interface 400 may include a dial 402 that indicates the status of one or more vehicles of a particular type being manufactured. Further, the dial 402 may illustrate the various manufacturing stages involved in manufacturing the vehicle. Thus a user viewing the user interface 400 can determine the completed manufacturing stages and the manufacturing stages yet to be completed. Further, the user interface 400 may show the manufacturing status for a set of one or more vehicles of the same type. Typically, the set of vehicles are vehicles of an identical type. However, in some cases, the set of vehicles may not be identical but may share one or more features in common. For example, the set of vehicles may be vehicles of the same model, but may be different versions of the model (e.g., subtypes or sub models).

In cases where the user interface 400 presents the status of a plurality of vehicles, the dial 402 may show the status of the vehicle from the set of vehicles that is closest to completion of manufacture. Alternatively, the dial 402 may show the status of the vehicle that is furthest from completion of manufacture. In some cases, the user may configure the dial 402 to show either the status of the vehicle closest completion or furthest from completion of manufacture.

In addition, the user interface 400 may include a map 404 that illustrates the current location of the vehicle being manufactured. In some embodiments, a user may interact with the map 404 to obtain a history log of all the locations the vehicle 102 has visited. The log may be presented as a list, may be illustrated on the map 404, or may use another form that can present the location history to a user. The log may also show manufacturing locations (e.g., of additional outfitters or manufacturers) that the vehicle 102 is scheduled to visit in the future. The listing of the future locations may also indicate when the vehicle 102 is expected to visit the future locations. Further, as with the user interface 300, the user interface 400 may include a share button 406 that enables a user to share the status information for one or more vehicles with other users. In some cases, as with the share button 306, the share button 406 enables the user to share the status information with one or more systems, such as the vehicle management system 150.

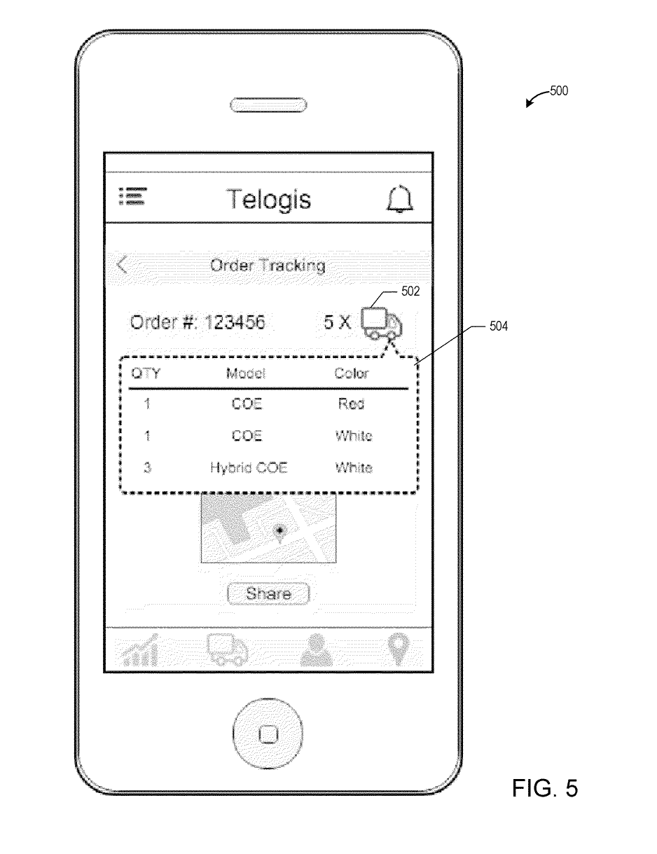

FIG. 5 illustrates an embodiment of a second user interface 500 for accessing vehicle information for vehicles under construction at a particular manufacturing stage. In some implementations, the second user interface 500 is a modified form of the user interface 400 generated in response to a user interacting with the icon 502. By selecting or interacting with the icon 502, a panel 504 may be generated that provides additional details regarding the types of vehicles grouped together for purposes of status tracking.

In the particular example illustrated in FIG. 5, the panel 504 displays the different versions and colors for the model of the vehicle represented by the icon 502 whose status is being presented on the user interface 500. However, the types of information that may be displayed via the panel 504 are not limited to the example illustrated in FIG. 5. Any type of additional details regarding the set of vehicles whose status is presented via the user interface 500 may be included in the panel 504. For example, the panel 504 may present the individual manufacturing status for each vehicle. In other words, in some cases, while the user interface 400 may present the status of the vehicle in the set of vehicles that is furthest along or least furthest along in the manufacturing process, the panel 504 may present a specific status of each vehicle that has been included in the set of vehicles. As another example, the panel 504 may present anticipated delivery times for each vehicle within the set of vehicles.

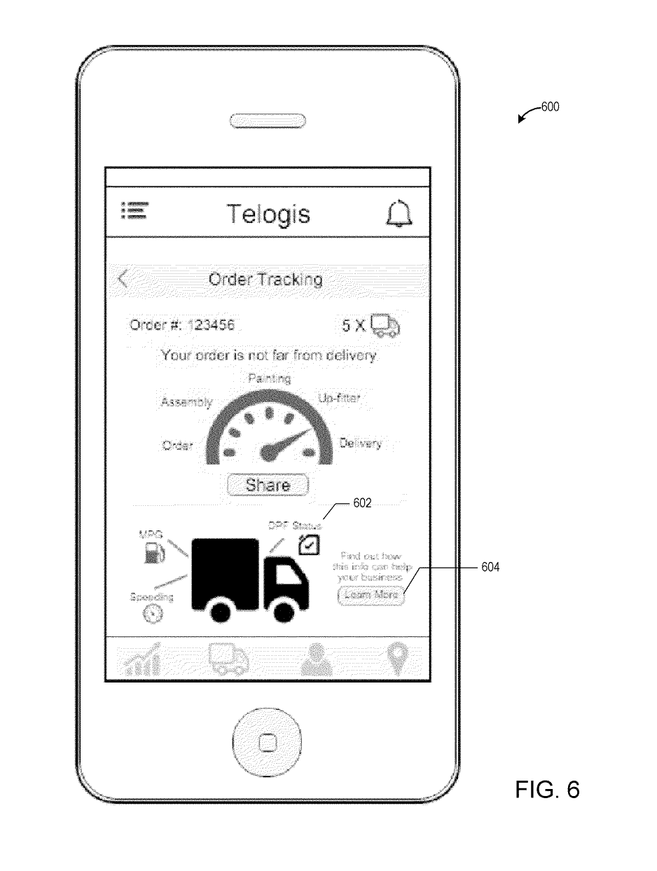

FIG. 6 illustrates an embodiment of a third user interface 600 for accessing vehicle information for vehicles under construction at a particular manufacturing stage. The user interface 600 is similar to the user interface 400. However, the map 404 of the user interface 400 is replaced by a diagnostics image 602. This diagnostics image 602 may present particular features of the vehicle that should be inspected upon delivery of the vehicle. Alternatively, or in addition, the diagnostics image 602 may present particular features of the vehicle that should be monitored to maintain the vehicle in a particular working condition, such as a condition that maximizes fuel economy or that maintains the street-legal status of the vehicle for a particular geopolitical region.

User interface 600 may also include a button 604 that a user may interact with to learn more about the various diagnostics or features illustrated by the diagnostics image 602. By interacting with the button 604, a user may be presented with steps on how to perform diagnostics for particular features. Alternatively, or in addition, by interacting with the button 604, the user may be presented with information relating to why a particular feature should be monitored. In some cases, interacting with the button 604 may present a user with an option to obtain (e.g., download, license, purchase) software to facilitate with the maintenance and/or diagnostics-checking of the vehicle to be delivered.

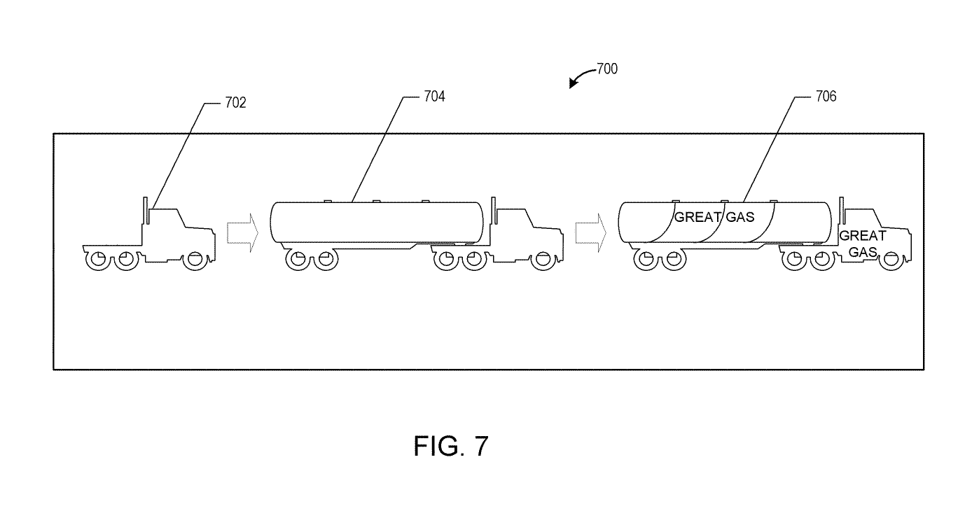

FIG. 7 illustrates an embodiment of a portion of a user interface 700 for presenting the assembly status of a vehicle. This portion of the user interface 700 may be presented in a user device or in a similar user interface as presented in the FIGS. 3-6. User interface 700 enables the user to view a status of a vehicle being manufactured. In this particular example, user interface 700 illustrates status images, status image 702 representing the manufacture of the core of the truck, status image 704 representing the manufacture and/or installation of the container, carrier, or other non-limiting element attached to the core of the truck, and status image 706 representing the painting of the truck. It should be understood that while the user interface 700 illustrates three status images, more or fewer status images may be presented by the user interface 700. For example, an additional status image may be included in the user interface 700 to represent the delivery of the vehicle. As another example, an additional status image may be included in the user interface 700 to represent the installation of an engine into the core of the vehicle. As yet another example, an additional status image may be included in the user interface 700 to represent the quality assurance testing of the vehicle.

In some cases, the user interface 700 enables the user to view a status of a particular vehicle being manufactured that is specific to the vehicle. In other words, as the assembly management system 110 can access information specific to the vehicle, the user interface 700 can illustrate different stages of the vehicle that are specific to the requisitioned vehicle. For example, suppose that the entity requisitioning the vehicle is a fuel delivery entity called “GREAT GAS.” Further, suppose that the entity GREAT GAS has a particular paint pattern that makes it vehicles recognizable to the general public. The user interface 700 may show a status image 706 with the logo and paint pattern that is specific to the vehicles of the entity GREAT GAS. In other words, rather than the status image 706 associated with the paint manufacturing stage of the manufacturing process being a generic status image, the status image 706 may be particular to the entity that has requisitioned the vehicle. Similarly, rather than the status image 704 using a generic image to indicate that the manufacturing stage corresponding to the status image 704 relates to the installation of the cargo container or other element to be hauled by the core of the truck, a specific image indicating that a container for hauling gasoline is being installed can be used for the status image 704. Thus, if the vehicle whose status is being displayed in the user interface 700 was instead a refrigerated food delivery truck, the status image 704 may be replaced with an image that reflects the installation of a refrigerated box carrier or container.

In some cases, the status images 702, 704, 706 are presented when the corresponding manufacturing stage is completed or is in progress. In other words, if only the core of the truck has been manufactured, user interface 700 may illustrate only the status image 702. Manufacturing stages that are in process may be represented by a modified form of the status image. For example, if the core of the truck has been completed, represented by the status image 702, and the cargo container portion of the vehicle, represented by the status image 704, is in the process of being manufactured, the status image 702 may be presented using solid lines and the status image 704 may be presented using dashed lines or using a different shading compared to the status image 702. Alternatively, continuing the above example, the status image 704 may be presented as a flashing image while the status image 702 may be presented as a static image, thereby differentiating between a completed manufacturing stage and a manufacturing stage in progress. Further, the status image 706 may not be presented in the previous example because the manufacturing stage associated with the status image 706 is yet to be reached.

Further, although the status images 702, 704, and 706 are illustrated as static images, this disclosure is not limited as such. In other words, the status images 702, 704, and 706 may be animated. For example, the status image 704 may illustrate an animation of a cargo container being formed and installed on the core of the truck. This animation may be played once when the user interface 700 is accessed, may be played repeatedly, and/or may be played in response to a user interacting with the user interface 700.

### Example Vehicle Status Monitoring Process

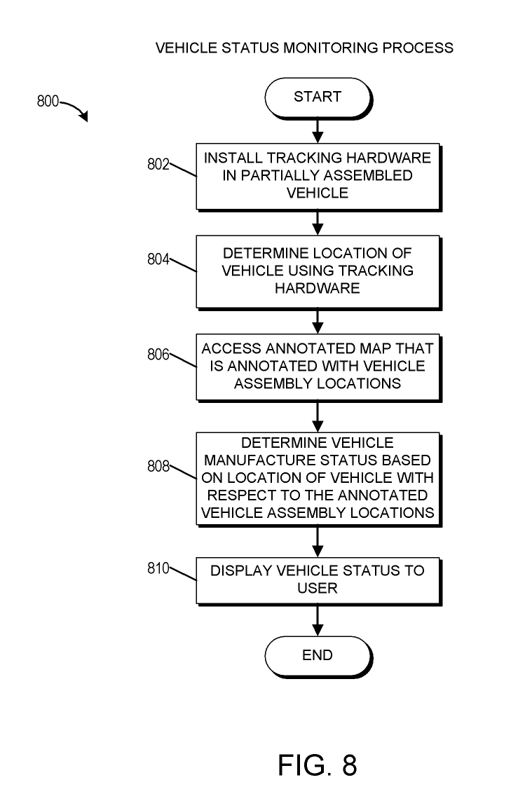

FIG. 8 presents a flowchart of an embodiment of a vehicle status monitoring process 800. The process 800 can be implemented by any system that can monitor the manufacturing process of a vehicle (e.g., a truck), which may occur at multiple locations. Further, the process may include generating a user interface illustrating the manufacturing status of the vehicle for display to a user. In some embodiments, for example, the process 800, in whole or in part, can be implemented by an assembly management system 110, a location server 114, a vehicle status tracking system 116, a user interface system 118, or tracking hardware 104, to name a few. Although any number of systems, in whole or in part, can implement the process 800, to simplify the discussion, portions of the process 800 will be described with reference to particular systems.

The process 800 begins at block 802 where tracking hardware 104 is installed in a partially assembled vehicle (e.g., vehicle 102). The tracking hardware 104 may be installed by a user or by an automated system on an assembly line. Further, the tracking hardware 104 may be associated with a particular requisition or order number. This number may be obtained from a requisition request or order placed for the vehicle. Alternatively, or in addition, the number may include the vehicle identification number (VIN) number for the vehicle. The tracking hardware 104 may be installed in a location of the vehicle that will not interfere with the manufacture and/or operation of the vehicle. Further, the tracking hardware 104 may be installed in a location that will cause minimal or no interference with communication with the tracking hardware 104. In some cases, the tracking hardware 104 is installed temporarily and may be removed upon delivery of the vehicle, or at some other designated time. Alternatively, the tracking hardware 104 may be installed permanently. Further, in some cases, the tracking hardware 104 may be integrated as part of an ongoing maintenance or tracking system. For example, the tracking hardware 104 may continue to be used by, for example, a vehicle dispatcher to assign the vehicle to a driver and to track the vehicle's location.

As previously described, the tracking hardware 104 may include a GPS receiver or other hardware for facilitating determination of a location of the vehicle 102 being manufactured. In some cases, the tracking hardware 104 may be installed by an automated system or robot, but may be configured by a user to associate the vehicle 102 with a particular requisition request or order. In other cases, installation of the tracking hardware 104 and the configuration of the tracking hardware 104 may be part of an automated process.

At block 804, the location server 114 using tracking hardware 104 determines a location of the vehicle 102. Location of the vehicle 102 may be determined based on information received from the tracking hardware 104 via the network 108. This information may include a GPS signal, mapping coordinates, or other information that may be used to determine a geographical location of the vehicle 102.

The location server 114 accesses from, for example, a map repository 112 an annotated map that is annotated with vehicle assembly locations or manufacturing locations at block 806. The annotated map may include annotations, such as geo-fencing outlines, that identify a location where the core of the truck is manufactured or assembled as well as various additional manufacturing locations that may be associated with an entity that manufactured the core of the truck or different entities. For example, the annotations may identify the locations of various outfitters, painters, aftermarket assemblers, etc. Further, in some cases, the annotations may include the identity of the location associated with delivering the manufactured vehicle to a dealer or the requisitioning entity. It should be understood that the annotated locations may have varying levels of granularity. For example, the virtual geo-fence that identifies a particular manufacturing location may precisely surround the manufacturing location or may surround a particularly sized area that includes the manufacturing location. For instance, a manufacturing location that is the size of one square block may be surrounded by a virtual geo-fence that is five square blocks. As another example, the virtual geo-fence may surround a geographic area that includes all points that are up to 1, 2, or 5 miles (or some other particular distance) away from the manufacturing location.

As previously discussed, although the map repository 112 may store one or more annotated maps, in some implementations the map repository 112 may not actually store maps. Instead, the map repository 112 may store data that can be used to determine where the vehicle 102 is located in relation to one or more identified manufacturing locations based on the location of the vehicle 102 as determined by tracking hardware 104 or as determined by information provided by the tracking hardware 104.

At block 808, the vehicle status tracking system 116 determines the vehicle manufacture status of the vehicle 102 based, at least in part, on the location of the vehicle 102 with respect to the annotated vehicle assembly locations as determined from the map accessed at the block 806 or other location information stored in the map repository 112. In some cases, the block 808 may include determining a history of locations by the vehicle 102 so as to determine the manufacturing status of the vehicle 102. The manufacturing status of the vehicle 102 may be determined based on one or more of the following: the current location of the vehicle 102; a geo-fenced location entered by the vehicle 102; a geo-fenced location exited by the vehicle 102; a route traveled by the vehicle 102, whether the vehicle 102 is located at an unexpected location; an amount of time the vehicle 102 is at a particular location; and the like.

Using the vehicle manufacturing status of the vehicle 102, it can be determined whether assembly or manufacture of the vehicle is ahead of schedule, behind schedule, or is occurring as expected. Further, based on the vehicle manufacturing status of the vehicle 102, the assembly management system 110 can determine an estimate for the delivery time or date of the vehicle 102. This estimated delivery schedule may be reported to a recipient or requisitioning entity of the vehicle enabling the user to plan accordingly.

By determining the vehicle manufacturing status of the vehicle 102, it is also possible to determine status information relating to an outfitter. For example, if a vehicle 102 is determined to be at a particular outfitter for an unexpected period of time, it may be determined that the outfitter is behind schedule. Advantageously, by determining that the outfitter is behind schedule, it is possible for other vehicles being manufactured to have their manufacturing schedule altered. For instance, if several steps in the manufacturing process can be performed in varying order, the assembly management system 110 may direct the vehicle to a different outfitter to perform a different stage of the manufacturing process before sending the vehicle to the delayed outfitter. Alternatively, the assembly management system 110 may select an alternative outfitter for the delayed outfitter or redistribute work among multiple outfitters.

In some embodiments, the block 808 may use additional information to confirm the status of the vehicle 102 being manufactured or to determine the status with a finer granularity. For example, in some cases, a machine-readable code, such as a barcode or Quick Response (QR) code, may be scanned by a user at a manufacturing facility to indicate that a particular portion of the assembly process has been completed or is being initiated, or that a particular part has been installed. Alternatively, the machine-readable code may be scanned automatically by a machine or robot that is assembling a portion of the vehicle. The scanning of the machine-readable code may be communicated to the assembly management system 110, which can use this information to facilitate determining the manufacturing status of the vehicle 102. The scanning of the machine-readable code may be communicated via the tracking hardware 104 and/or by the system that scanned the machine-readable code. In some cases, the tracking hardware 104 installed into the vehicle 102 being built may scan a machine-readable code to determine a manufacturing status. This code may be at a facility, on an assembly line, or on a robot working on the assembly line. As another example, the installation or activation of a particular part may cause a signal (e.g., a test signal or an activation signal) to be automatically communicated to a vehicle management system and/or to the assembly management system 110, which can use this information to help determine the manufacturing status of the vehicle 102. For instance, the initial activation of a power takeoff (PTO) motor, or a mechanical system or machine that obtains power from a running engine, may result in a signal being transmitted that is indicative of the operation of the PTO motor. Thus, the assembly management system 110 could determine with or, in some cases, without the location information of the vehicle 102 the manufacturing status of the vehicle 102.

At block 810, the user interface system 118 displays a vehicle status to a user. Alternatively, the user interface system 118 may provide the vehicle status to a user computing device 120, which can display the vehicle status to the user. In some cases, the vehicle status information may be provided to the vehicle management system 150. In certain embodiments, the block 810 is performed in response to a request by a user. Alternatively, or in addition, the block 810 may be performed automatically. For example, the status of the vehicle being manufactured may be pushed to a user computing device 120 associated with the user. This status information may be provided to the user using a variety of communication technologies. For example, the status information may be presented in a user interface of an application, emailed to a user, texted to a user (e.g., via a short message service (SMS) text), in a pop-up window of an application, via a webpage or other network page, via a telephone call, via a voicemail message, etc. In certain embodiments, status information may be provided to a user without the use of an application or app on the user computing device 120. For example, as stated above, the status information may be emailed to the user.

In some cases, whether the vehicle status is pushed to a computing device associated with the user may depend on the particular status of the vehicle being manufactured. For example, if the vehicle status indicates that the vehicle being manufactured is at an early stage in the manufacturing process, such as a stage related to manufacturing the core of the vehicle, the vehicle status may not be pushed to a user computing device 120. Alternatively, if the vehicle status indicates that the vehicle will soon be delivered, such as when the vehicle status indicates that the vehicle is being painted, the vehicle status may be pushed to a user computing device 120 or to a vehicle management system 150 so that an entity that requisitioned the vehicle can prepare for the delivery of the vehicle, such as by integrating the vehicle into the entity's route scheduling process. Moreover, if the vehicle status indicates that the vehicle will be delivered ahead of schedule, the requisitioning entity may begin attempts to acquire new business sooner or begin the process of retiring an old vehicle sooner. Alternatively, if the vehicle status indicates that the vehicle will be delayed, the entity may delay the retirement of a vehicle or delay the acquisition of new contracts.

In some implementations, the vehicle status is pushed or provided to a user based on a trigger event. For example, each time a geo-fence is breached by the vehicle 102 (e.g., each time the vehicle 102 enters or exists a location surrounded by a geo-fence), the status of the vehicle 102 being manufactured may be determined and/or made available to a user. In some cases, the triggers may vary based on the entity associated with the user. For example, a user associated with the OEM may receive a status update each time the vehicle 102 enters or exits a geo-fenced location. But, a user associated with the requisitioning entity may receive status updates when the vehicle 102 exits some geo-fenced locations (e.g., locations associated with the completion of particular manufacturing stages), but may not receive status updates when the vehicle 102 exits some other geo-fenced locations. Trigger events are not limited to the crossing of geo-fences by the vehicle 102 being manufactured and may include a variety of other events. For example, trigger events may be based on the passage of time since the vehicle is requisitioned, ordered, or a particular manufacturing step occurs. Further, a trigger event may be based on the amount of time that the vehicle is within a geo-fenced location. In some cases, the trigger event may be the completion of a manufacturing stage in a set of manufacturing stages or of a particular manufacturing stage from the set of manufacturing stages. These manufacturing stages may be determined by the OEM or another entity involved in the requisitioning or manufacture of the vehicle 102.

The status information that is presented to a user at the block 810 may differ based on the user. For example, in some cases, the specific location of the vehicle may be presented to a representative of an OEM, but not to a representative of a requisitioning entity. Further, the identity of an outfitter that is delayed may be presented to the representative of the OEM, but not to the representative of the requisitioning entity. However, the delay or an updated delivery schedule may be displayed to the representative of the requisitioning entity.

The determination of a delivery schedule may be based on a status of the vehicle 102 being manufactured as well as a history of vehicle deliveries. In some cases, the assembly management system may use one or more machine learning algorithms to estimate a delivery date for a particular vehicle. Further, the machine learning algorithms can be used to update an expected delivery date based on the status of the vehicle and the identity of the outfitter, or OEM, responsible for the delay.

In some cases, the block 810 provides the status of a single vehicle being manufactured for display to a user. However, in other cases, as illustrated by the user interface examples of FIGS. 3-7, the status information may be presented for a plurality of vehicles being manufactured. In such cases, status information may be obtained for individual vehicles and the status information may be output, for display, separately for each vehicle. Alternatively, or in addition, the individual status information may be aggregated and output for display. For example, vehicles of the same model may have status information aggregated. As a second example, vehicles with a shared status may be aggregated for display. As yet another example, status information may be aggregated based on time periods. For instance, status information may be aggregated on a daily, weekly, or monthly basis to display the status of vehicles being manufactured over the selected time period. In other cases, vehicle status information may be aggregated based on anticipated delivery dates or on delivery delays. Furthermore, status information may be aggregated per OEM, per customer or requisitioning entity, and/or per outfitter.

When the vehicle 102 is delivered to a dealer or a requisitioning entity, the tracking hardware 104 may be deactivated. The deactivation may occur remotely or by a user responsible for delivering the vehicle 102. Alternatively, the tracking hardware 104 may remain active and can be used to facilitate operation of the vehicle management system 150, a vehicle maintenance system, or other systems that can utilize location tracking. In some embodiments, the tracking hardware 104 may be used to identify a location of the vehicle 102 during its route. This information may also be used to help locate the vehicle 102 if it is stolen. In some cases, the tracking hardware 104 may be used to lock the vehicle 102 or to prevent its engine from being started. A fleet manager or enforcement officer (e.g., policeman) may lock the vehicle or prevent its engine from being started if it is determined that the vehicle 102 is stolen.

### Vehicle Management System Overview

FIG. 9 illustrates an embodiment of a vehicle management system 150 within a computing environment 900. It should be understood that the computing environment 900 may include the vehicle manufacturing-status system 100. Further, as described above, the vehicle management system 150 may be in communication with the assembly management system 110.

Among other features, the vehicle management system 150 can determine custom street classifications for streets of a network of streets, or a road network, and perform vehicle routing on the network of streets using the custom classifications. Further, the vehicle management system 150 may select access paths at a site that can serve as a constraint on selecting a route. In some cases, the vehicle management system 150 may automatically select the access paths based, for example, on context information associated with a vehicle. In other cases, a user may specify an access path.

In the computing environment 900, one or more in-vehicle devices 905A . . . 905N (which may collectively be referred to as “in-vehicle devices 905”) and management devices 935 communicate with the vehicle management system 150 over a network 108. The in-vehicle devices 905 can include computing devices and sensors installed in fleet vehicles. These devices 905 can include navigation functionality, routing functionality, and the like. The in-vehicle devices 905 can receive route information and other information from the vehicle management system 150. In addition, the in-vehicle devices 905 can report information to the vehicle management system 150, such as driver location, vehicle sensor data, vehicle status (e.g., maintenance, tire pressure, or the like), vehicle type, cargo, vehicle direction, and so forth.

In some embodiments, the in-vehicle devices 905 may include the tracking hardware 104 installed in a vehicle 102 during the manufacturing process of the vehicle 102. In other cases, the tracking hardware 104 may be independent from the in-vehicle devices 905.

The management devices 935 can be computing devices used by dispatchers, fleet managers, administrators, or other users to manage different aspects of the vehicle management system 150. For example, a user of a management device 935 can access the vehicle management system 150 to generate routes, dispatch vehicles and drivers, define access paths, select access paths, update site details information for a site, and perform other individual vehicle or fleet management functions. With the management devices 935, users can access and monitor vehicle information obtained from one or more of the in-vehicle devices 905 by the vehicle management system 150. Such vehicle status information can include data on vehicle routes used, stops, speed, vehicle feature usage (such as power takeoff device usage), driver behavior and performance, vehicle emissions, vehicle maintenance, energy usage, and the like. In some embodiments, the management devices 935 are in fixed locations, such as at a dispatch center. The management devices 935 can also be used by administrators in the field, and may include mobile devices, laptops, tablets, smartphones, personal digital assistants (PDAs), desktops, or the like.

The vehicle management system 150 can be implemented by one or more physical computing devices, such as servers. These servers can be physically co-located or can be geographically separate, for example, in different data centers. In one embodiment, the vehicle management system 150 is implemented as a cloud, or network-based, computing application. For instance, the vehicle management system 150 can be a cloud-implemented platform hosted in one or more virtual servers and/or physical servers accessible to users over the Internet or other network 108. In the depicted embodiment, the vehicle management system 150 includes a routing module 910, a mapping module 915, a workforce management module 920, an integration module 930, a dispatch module 940, and a fleet management module 925. These components can, but need not, be integrated together on a common software or hardware platform.

The fleet management module 925 can include functionality for generating, rendering, or otherwise displaying a vehicle management user interface. The vehicle management user interface can include a map or list of vehicles that depicts symbols or other data representative of vehicles.

As used herein, the terms “output a user interface for presentation to a user,” “presenting a user interface to a user,” and the like, in addition to having their ordinary meaning, can also mean (among other things) transmitting user interface information over a network, such that a user device can actually display the user interface.

The fleet management module 925 can communicate with the mapping module 915 to obtain mapping data, which the fleet management module 925 can include in the vehicle management user interface. The mapping data can be compressed, transmitted, re-rendered, and displayed on the management user interface. Other data can also be overlaid to enhance the map and management layout. The mapping module 915 can be a geographic information system (GIS) in one embodiment. The fleet management module 925 can also access vehicle status data based on telematics data obtained from the in-vehicle devices 905. The telematics data can include such data as location or speed information obtained using GPS or cellular tower triangulation (or other methods), vehicle sensor data, solid state inertial information, or any other data that can be obtained from a vehicle, its engine, or the like (including other sensors such as passenger seat sensors to detect the presence of passengers and so forth).

The routing module 910 can implement any of the routing features described above. In addition, the routing module 910 can construct pre-dispatch or post-dispatch routes for vehicles based on any of a variety of routing algorithms, such as those disclosed in U.S. Publication No. 2010/0153005, filed Dec. 8, 2009, and entitled “System and Method for Efficient Routing on a Network in the Presence of Multiple-Edge Restrictions and Other Constraints,” the disclosure of which is hereby incorporated by reference in its entirety. The routing module 910 can automatically select routes that take into account factors that affect energy usage using the techniques described in U.S. Publication No. 2011/0238457, filed Nov. 24, 2010, and entitled “Vehicle Route Selection Based on Energy Usage,” the disclosure of which is hereby incorporated by reference in its entirety.

In some embodiments, the routing module 110 may resolve discrepancies between an access path and a road network. Typically, the routing module 910 determines the location of roads within a road network based on mapping data provided to the routing module 910. The mapping data may, in some cases, vary over time. For example, a provider of the mapping data may slightly modify the mapping data based on technical decisions by the provider. As another example, the road network, in this mapping data, may change over time due to construction, such as lane expansion. Thus, discrepancies may build up over time between alignment of access paths and road networks external to sites. Advantageously, in certain embodiments, the routing module 910 may use one or more algorithms to realign the access paths with the road networks. Further, in some cases, the realignment algorithms can be used to realign the virtual nodes of an overlay network with the nodes representing the roads in the road network. Some examples of algorithms that may be used to realign the access path road network include fitted history algorithms, which are described in more detail with respect to U.S. Publication No. 2012/0226391, filed Mar. 2, 2012, and entitled “Vehicle Route Calculation,” the disclosure of which is hereby Incorporated by reference in its entirety.

The integration module 930 can facilitate integration of the vehicle management system 150 with other systems, such as fuel card systems, payroll systems, supply chain system, insurance systems, and the like. The dispatch module 940 can provide functionality for users of the management devices 935 to assign drivers and vehicles to routes selected by the routing module 910. The workforce management module 920 can provide functionality for users of the management devices 935 to schedule drivers and to monitor drivers working hours and driving hours. Advantageously, in certain embodiments, the workforce management module 920 may be used in conjunction with the dispatch module 940 and the routing module 910 to ensure that drivers comply with regulations relating to the number of hours fleet drivers are permitted to drive in a day, week, or other period of time.

The routing module 910, the dispatch module 940, and the workforce management module 920 can each be updated based on the status information received from the assembly management system 110 for one or more vehicles requisitioned by an entity associated with the vehicle management system 150. For instance, if a set of vehicles is expected to be delivered within the week, the vehicle management system 150 can be updated to include the identity of the soon to be delivered vehicles, as well as the capabilities and delivery location(s) for the vehicles. Thus, a user of a management device 935 can update driver/route assignments based on the anticipated availability of the new vehicles. Further, if status information provided by the assembly management system 110 indicates that a vehicle will be delivered earlier, or later, than originally anticipated, the set of available vehicles can be updated accordingly so that the vehicle can be included in or removed from the rotation of vehicles used in the route assignments generated by the management devices 935, or users of the management devices 935.

For ease of illustration, the vehicle management system 150 has been depicted as a centralized system. However, in other implementations, at least some of the functionality of the vehicle management system 150 is implemented in other devices. Other possible implementations of the vehicle management system 150 can include many more or fewer components than those shown in FIG. 9.

The vehicle management system 150 may also include a number of repositories. For example, the vehicle management system 150 may include a site details repository 942, a fleet data repository 944, and a third-party repository 946. The site details repository 942 may store any type of site information associated with a site. For example, the site information may include an identity of gates, an identity of site locations within the site, hours of access, the identity of specific roads and a road network that should be used or excluded from use by vehicles of a vehicle fleet servicing the site, whether drivers have permission to park their vehicles overnight at the site, etc. further, in some cases, the site information may include a map of the site.

The fleet data repository 944 may include any type of site information that is collected by particular vehicle fleet, or its users. In some cases, the fleet data repository 944 may include a copy of at least some of the information stored at the site details repository 942 that is accessible by users (e.g., drivers or dispatch operators) of the particular vehicle fleet. Advantageously, in certain embodiments, by including a separate fleet data repository 944 that can be associated with a vehicle fleet, users can annotate site information. For example, users can define access paths and decide whether or not to share the defined access paths with other vehicle fleets.

The third-party repository 946 can include any information that can be obtained from third-party sources that may relate to the site. For example, the third-party repository 946 may include property tax information that enables the vehicle management system 150 to identify the property boundaries of a site. As another example, the third-party repository 946 may include weather information, traffic information, or local town ordinance information that may be used to facilitate generating a route to a site or determining an access path.

Although the site details repository 942, the fleet data repository 944, and the third-party repository 946 are illustrated as being part of the vehicle management system 150, in some embodiments one or more of the repositories may be separate systems, which may or may not be affiliated with separate entities. In some embodiments, different entities may be associated with or in control of separate vehicle management systems 150. Each of these entities or vehicle management systems 150 may have access to a single shared site details repository 942 that is implemented in a system that is separate from the vehicle management systems 150. Similarly, one or more of the fleet data repository 944 and the third-party repository 946 may be shared among vehicle management systems 150. Alternatively, one or more of the vehicle management systems 150 may have its own fleet data repository 944 and/or third-party repository 946.

### Additional Embodiments

The systems, methods and devices of this disclosure each have several innovative aspects, no single one of which is solely responsible for the all of the desirable attributes disclosed herein. Details of one or more implementations of the subject matter described in this specification have been set forth in the accompanying drawings and the description above. Some additional embodiments are set forth below.

Certain embodiments disclosed herein relate to a vehicle manufacturing-status system. The system may include an assembly management system comprising computer hardware. This assembly management system may be configured to receive, from tracking hardware, a location of a vehicle being manufactured. Further, the assembly management system may be configured to access an annotated map that is annotated with a plurality of geo-fences. At least some of the geo-fences may identify a manufacturing location. Moreover, the assembly management system may determine a current manufacturing location of the vehicle being manufactured based at least in part on the location of the vehicle being manufactured and the annotated map. In addition, the assembly management system may determine a manufacturing status of the vehicle being manufactured based at least in part on the current manufacturing location.

In some embodiments, the assembly management system is further configured to provide the manufacturing status to a display for output to a user. Some implementations of the system may include a vehicle management system comprising computer hardware. The vehicle management system may be configured to receive the manufacturing status of the vehicle and to update vehicle fleet status information based at least in part on the manufacturing status of the vehicle. Further, the vehicle management system may use the vehicle fleet status information to assign drivers and vehicles to particular vehicle routes.

In some cases, the plurality of geo-fences distinguishes between locations associated with manufacturing of a core portion of the vehicle and locations associated with one or more outfitters associated with installing application-specific elements to the core portion of the vehicle. Further, each geo-fence may surround a geographic location. Moreover, the identification of the location of the vehicle being manufactured with respect to the geographic location may indicate a status of the vehicle being manufactured. In addition, the vehicle management system may be further configured to estimate a delivery time of the vehicle being manufactured based at least in part on the location of the vehicle being manufactured and the annotated map.

In certain embodiments, the vehicle management system is further configured to identify a delay by an outfitter based at least in part on a second location associated with a second vehicle being manufactured and the annotated map. Moreover, the vehicle management system can be further configured to redirect the vehicle being manufactured to an alternative outfitter based at least in part on the identified delay by the outfitter. In addition, the vehicle management system may be further configured to modify a manufacturing process order based at least in part on the identified delay by the outfitter. Modifying the manufacturing process order may comprise altering an order in which the vehicle being manufactured visits a plurality of outfitters. The plurality of outfitters may include the outfitter associated with the delay.

Some implementations of the system further include the tracking hardware. This tracking hardware may comprise a space-based navigation system receiver configured to receive a signal from a satellite and to determine the location of the vehicle being manufactured based at least in part on the signal. In some cases, the tracking hardware is configured to provide the location information of the vehicle being manufactured to the assembly management system.

Certain additional embodiments disclosed herein relate to a computer-implemented method of determining a vehicle manufacturing status of a vehicle. The computer-implemented method may be performed by a vehicle manufacturing-status system comprising non-volatile storage and one or more hardware processors. The method may include receiving, from tracking hardware, a location of a partially manufactured vehicle. Further, the method may include accessing an annotated map that is annotated with a plurality of geo-fences. Each geo-fence of the plurality of geo-fences may correspond to a different manufacturing location of the partially manufactured vehicle. In addition, the method may include determining a current manufacturing location of the partially manufactured vehicle based at least in part on the location of the partially manufactured vehicle and the annotated map. The method may further include determining a manufacturing status of the partially manufactured vehicle based at least in part on the current manufacturing location.

In some implementations, the method may further include receiving the manufacturing status of the partially manufactured vehicle and updating vehicle fleet status information based at least in part on the manufacturing status of the partially manufactured vehicle. The vehicle fleet status information may be used to assign drivers and vehicles to particular vehicle routes.

Further, in some cases, the plurality of geo-fences distinguishes between locations associated with manufacturing different portions of the partially manufactured vehicle. Moreover, at least a first geo-fence of the plurality of geo-fences may be associated with a first manufacturing location associated with manufacturing a core portion of the partially manufactured vehicle and at least a second geo-fence of the plurality of geo-fences locations may be associated with a second manufacturing location associated with manufacturing one or more customizable portions of the partially manufactured vehicle.

In some embodiments, the method may further include modifying a manufacturing process associated with the partially manufactured vehicle based at least in part on the manufacturing status of the partially manufactured vehicle. Moreover, the method may include identifying a manufacturing delay based at least in part on the manufacturing status of the partially manufactured vehicle. In addition, the method may include modifying a set of driver assignment rules based at least in part on the manufacturing status of the partially manufactured vehicle. The driver assignment rules may comprise rules for distributing drivers or vehicles among a number of routes. In some cases, at least some of the plurality of geo-fences are part of a tiered set of geo-fences corresponding to a single manufacturing location. In some such cases, the method further comprises updating the manufacturing status of the partially manufactured vehicle in response to determining that the partially manufactured vehicle is located within a particular geo-fence from the tiered set of geo-fences.

Certain additional embodiments disclosed herein relate to a non-transitory computer-readable storage medium storing computer executable instructions that, when executed by one or more computing devices, configure the one or more computing devices to perform operations comprising receiving, from tracking hardware, a location of a partially manufactured vehicle. The operations may further include accessing an annotated map that is annotated with a plurality of geo-fences. At least some of the geo-fences of the plurality of geo-fences may correspond to different manufacturing locations of the partially manufactured vehicle. Moreover, the operations may include determining a current manufacturing location of the partially manufactured vehicle based at least in part on the location of the partially manufactured vehicle and the annotated map. In addition, the operations may include determining a manufacturing status of the partially manufactured vehicle based at least in part on the current manufacturing location.

Although certain embodiments and examples are disclosed herein, inventive subject matter extends beyond the examples in the specifically disclosed embodiments to other alternative embodiments and/or uses, and to modifications and equivalents thereof.

### Terminology

As used herein, the term “road” in addition to having its ordinary meaning, can include, among other things, a street, a highway, a freeway, a toll road, a turnpike, an arterial road, a frontage road, an on-ramp, an off-ramp, a city street, a surface street, a residential street, a dirt road, a parking lot, a driveway, an intersection, a traffic circle, a roundabout, a rotary, an alley, any path upon which a vehicle can travel, combinations of the same, or the like. Further, although this specification refers primarily to streets for automobiles, trucks, and the like, the techniques described herein can also be applied to paths traveled by other vehicles, such as railroads, flight paths, and waterways. Moreover, the techniques described herein may also be applied for mixed mode routing. In other words, the embodiments disclosed herein may be used to determine access paths routes that include the use of multiple types of vehicles. For example, a route may be determined for a driver of the truck that also includes using a ferry. As another example, a route may combine the use of a car, a boat, and a train. In some cases, the mixed mode routing may also include a segment of walking, use of a bicycle, or public transportation, such as a subway or underground railroad network.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many variations other than those described herein will be apparent from this disclosure. For example, depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together. Execution in a cloud computing environment in some embodiments supports a multiplicity of conditions to be computed contemporaneously.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. For example, the assembly management system 110 can be implemented by one or more computer systems or by a computer system including one or more processors. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A vehicle manufacturing-status system comprising:
an assembly management system comprising computer hardware and configured to:
receive, from tracking hardware, a location of a vehicle being manufactured;
access an annotated map that is annotated with a plurality of geo-fences, at least some of the geo-fences identifying a manufacturing location;
determine a current manufacturing location of the vehicle being manufactured based at least in part on the location of the vehicle being manufactured and the annotated map; and
determine a manufacturing status of the vehicle being manufactured based at least in part on the current manufacturing location.

2. The vehicle manufacturing-status system of claim 1, wherein the assembly management system is further configured to provide the manufacturing status to a display for output to a user.

3. The vehicle manufacturing-status system of claim 1, further comprising a vehicle management system comprising computer hardware and configured to:
receive the manufacturing status of the vehicle; and
update vehicle fleet status information based at least in part on the manufacturing status of the vehicle, wherein the vehicle management system uses the vehicle fleet status information to assign drivers and vehicles to particular vehicle routes.

4. The vehicle manufacturing-status system of claim 1, wherein the plurality of geo-fences distinguishes between locations associated with manufacturing of a core portion of the vehicle and locations associated with one or more outfitters associated with installing application-specific elements to the core portion of the vehicle.

5. The vehicle manufacturing-status system of claim 1, wherein each geo-fence surrounds a geographic location and wherein the identification of the location of the vehicle being manufactured with respect to the geographic location indicates a status of the vehicle being manufactured.

6. The vehicle manufacturing-status system of claim 1, wherein the vehicle management system is further configured to estimate a delivery time of the vehicle being manufactured based at least in part on the location of the vehicle being manufactured and the annotated map.

7. The vehicle manufacturing-status system of claim 1, wherein the vehicle management system is further configured to identify a delay by an outfitter based at least in part on a second location associated with a second vehicle being manufactured and the annotated map.

8. The vehicle manufacturing-status system of claim 7, wherein the vehicle management system is further configured to redirect the vehicle being manufactured to an alternative outfitter based at least in part on the identified delay by the outfitter.

9. The vehicle manufacturing-status system of claim 7, wherein the vehicle management system is further configured to modify a manufacturing process order based at least in part on the identified delay by the outfitter, wherein modifying the manufacturing process order comprises altering an order in which the vehicle being manufactured visits a plurality of outfitters, the plurality of outfitters including the outfitter associated with the delay.

10. The vehicle manufacturing-status system of claim 1, further comprising the tracking hardware.

11. The vehicle manufacturing-status system of claim 10, wherein the tracking hardware comprises a space-based navigation system receiver configured to receive a signal from a satellite and to determine the location of the vehicle being manufactured based at least in part on the signal.

12. The vehicle manufacturing-status system of claim 1, wherein the tracking hardware is configured to provide the location information of the vehicle being manufactured to the assembly management system.

13. A computer-implemented method of determining a vehicle manufacturing status of a vehicle, the computer-implemented method comprising:
by a vehicle manufacturing-status system comprising non-volatile storage and one or more hardware processors,
receiving, from tracking hardware, a location of a partially manufactured vehicle;
accessing an annotated map that is annotated with a plurality of geo-fences, each geo-fence of the plurality of geo-fences corresponding to a different manufacturing location of the partially manufactured vehicle;
determining a current manufacturing location of the partially manufactured vehicle based at least in part on the location of the partially manufactured vehicle and the annotated map; and
determining a manufacturing status of the partially manufactured vehicle based at least in part on the current manufacturing location.

14. The computer-implemented method of claim 13, further comprising:
receiving the manufacturing status of the partially manufactured vehicle; and
updating vehicle fleet status information based at least in part on the manufacturing status of the partially manufactured vehicle, wherein the vehicle fleet status information is used to assign drivers and vehicles to particular vehicle routes.

15. The computer-implemented method of claim 13, wherein the plurality of geo-fences distinguishes between locations associated with manufacturing different portions of the partially manufactured vehicle, wherein at least a first geo-fence of the plurality of geo-fences is associated with a first manufacturing location associated with manufacturing a core portion of the partially manufactured vehicle and at least a second geo-fence of the plurality of geo-fences locations is associated with a second manufacturing location associated with manufacturing one or more customizable portions of the partially manufactured vehicle.

16. The computer-implemented method of claim 13, further comprising modifying a manufacturing process associated with the partially manufactured vehicle based at least in part on the manufacturing status of the partially manufactured vehicle.

17. The computer-implemented method of claim 13, further comprising identifying a manufacturing delay based at least in part on the manufacturing status of the partially manufactured vehicle.

18. The computer-implemented method of claim 13, further comprising modifying a set of driver assignment rules based at least in part on the manufacturing status of the partially manufactured vehicle, the driver assignment rules comprising rules for distributing drivers or vehicles among a number of routes.

19. The computer-implemented method of claim 13, wherein at least some of the plurality of geo-fences are part of a tiered set of geo-fences corresponding to a single manufacturing location, and wherein the method further comprises updating the manufacturing status of the partially manufactured vehicle in response to determining that the partially manufactured vehicle is located within a particular geo-fence from the tiered set of geo-fences.

20. A non-transitory computer-readable storage medium storing computer executable instructions that, when executed by one or more computing devices, configure the one or more computing devices to perform operations comprising:
receiving, from tracking hardware, a location of a partially manufactured vehicle;
accessing an annotated map that is annotated with a plurality of geo-fences, at least some of the geo-fences of the plurality of geo-fences corresponding to different manufacturing locations of the partially manufactured vehicle;
determining a current manufacturing location of the partially manufactured vehicle based at least in part on the location of the partially manufactured vehicle and the annotated map; and
determining a manufacturing status of the partially manufactured vehicle based at least in part on the current manufacturing location.
